(19) United States
(12) Patent Application Publication
(10) Pub. No.: US 2003/0072864 A1
(43) Pub. Date: Apr. 17, 2003

(54) Low calorie oils which develop characteristic flavor notes during frying

(76) Inventor: Bernard Charles Sekula, Lebanon Township, NJ (US)

Correspondence Address: Patent Department Attorney, Unilever Patent Department, 45 River Road, Edgewater, NJ, 07020, US

(21) Appl. No.: 09/968,095

(22) Filed: Oct. 1, 2001

(51) Int. Cl. A23D 7/00

(52) U.S. Cl. 426/601

(57) ABSTRACT

Frying oil compositions comprising fatty-acid esterified propoxylated glycerin having the fatty acids derived from natural beef or animal tallow. The compositions develop characteristic flavor notes during frying and impart a savory beefy or tallow flavor to the fried foods. The compositions are non-digestible and thus add no caloric content to the fried foods, and the compositions have significantly less cholesterol compared to conventional animal fats traditionally used as a frying oil for fried foods.

### BACKGROUND OF THE INVENTION

1. Field of the Invention

The present invention concerns low calorie oils comprising fatty acid-esterified propoxylated glycerin compositions (sometimes referred to herein as “EPG” in the singular form and as “EPGs” in the plural form), having animal or beef tallow fatty acids. The low calorie oils can be used for frying comestible goods, such as farinaceous materials like potatoes, and the low calorie oils have no cholesterol and contribute little or no calories to the food. The low calorie oils unexpectedly develop flavor notes, particularly a savory beefy or tallow flavor, which are imparted to food during frying. The flavor is reminiscent of the flavor imparted to foods fried in conventional tallow or tallow containing frying mediums, such as the flavor of french fried potatoes from commercial “fast food” type restaurants. This is particularly surprising since similar oil compositions prepared with fatty acids derived from soybean oil fail to impart characteristic beany flavor to fried foods.

2. Description of the Related Art

Tallow is a fat that historically has been preferred by retail food establishments and food service operations, particularly “fast-food” type restaurants, as a frying medium because of the distinct flavor associated with tallow. Edible tallow is generally obtained by rendering beef and/or mutton fat. Typically, anti-oxidants such as BHA and BHT are added to provide oxidative stability. Tallow is light yellow in color and has a mild pleasant flavor. The iodine value of tallow, as measured by AOCS Method Cd 1-25, is between 34 and 47 and tallow generally has a free fatty acid content of less than 0.2%. Tallow, however, is a fat and, as such, has a high caloric content and also contains cholesterol which, considering increasing public concerns, has all but eliminated the use of tallow as a frying medium.

One of the most prevalent concerns among people today is the amount of fat consumed in their daily diet. It is estimated that fat constitutes about 40% of the total calories in a western diet. Fats are consumed, for example, in meats, chocolates, sweet breads, oils and fried snacks. When conventional oil is used as a frying medium, the fat is absorbed into the food, thus undesirably adding fat to the fried substrate, while also desirably adding distinct flavor characteristics to the fried food to which consumers have become accustomed. Conventional fats used as frying mediums generally contribute around 9 calories per gram to the total caloric content of the comestible good. Thus, there is an enormous potential for a fat substitute or mimetic, which exhibits the desired characteristics of fats, including the organoleptic properties and flavor notes, but does not contribute the calorie density of conventional fats, i.e., approximately 9 calories per gram.

In addition to calorie concerns, the public has become increasingly concerned about the role of animal fat, and specifically the cholesterol content of those fats, in the incidence of cardiovascular disease and atherosclerosis. Animal fat, such as tallow, is absorbed into the substrate when used as a frying medium and thus, contributes both cholesterol and its high calorie content to the fried food. Thus, a fat substitute or mimetic is desired, which can replace conventional animal fat based frying mediums while imparting the traditional savory beefy or tallow flavor without cholesterol. A fat substitute or mimetic with these qualities should gain wide acceptance by the public which is concerned about cholesterol content of food, particularly foods fried with animal fat.

There is a need in the food service industry, particularly “fast-food” type restaurant operations, for oil replacement compositions that will impart the savory beefy or tallow like flavor to fried foods without adding the 9 calories per gram and cholesterol to the food contributed by natural tallow or animal fats. The invention described herein provides a fat replacement composition that is virtually calorie and cholesterol free which unexpectedly imparts a savory beefy or tallow like flavor to the food, and, accordingly the EPG composition described herein provides a frying medium needed by the food service industry and desired by the consuming public.

A number of fat substitutes are known which resist enzymatic hydrolysis and thus pass through the human digestive tract without being absorbed. One example of such a fat substitute is polyol fatty acid polyester (PPE), as shown in U.S. Pat. Nos. 3,251,827; 3,600,186 and 3,963,699. PPE is produced by the reaction of a monosaccharide, disaccharide or sugar alcohol having a minimum of four hydroxyl groups with fatty acids having from 8-22 carbon atoms. A number of methods are known for producing PPE, which basically include transesterification of the fatty acid methyl esters to the polyol. The PPE process requires long reaction time with alternating additions of fresh transesterification catalyst and excess soybean fatty acid methyl ester. In U.S. Pat. No. 3,251,827 a process for the preparation of PPE is disclosed which uses Q solvent-free interesterification using phenyl esters. U.S. Pat. No. 3,963,699 involves solvent-free transesterification to produce PPE.

Another example is U.S. Pat. No.4,861,613 to White et al. (referred to herein as “White” and incorporated by reference herein in its entirety). According to White, polyol such as glycerin must be reacted (epoxylated) with a quantity of C₃-C₆ epoxide sufficient to convert greater than 95 percent of primary hydroxyl groups of the polyol to the secondary or tertiary hydroxyl groups prior to esterification with fatty acids to obtain a non-digestible fat substitute. White teaches of use of esterified epoxide-extended polyol (EEEP), having present large amounts of secondary and tertiary linkages as a non-digestible fat substitute.

PPE and EEEP compounds possess the physical and organoleptic properties of conventional triglyceride lipids yet are significantly lower in available calories due to their pronounced resistance towards pancreatic lipase catalyzed hydrolysis. Unfortunately, as a consequence of their hydrolytic stability, low digestibility and lipophilic character, PPE and EEEP compounds which are liquid at body temperature may possess undesirable gastrointestinal side effects when consumed at high levels in the diet. These undesirable gastrointestinal side effects may include anal leakage, that is leakage of the fat substitute through the anal sphincter; and separation of the fat substitute from excreted stool.

Applications of the assignee of the invention involving the replacement of conventional fat in comestible products with EPG compositions are currently pending. These Applications involve the use of EPG compositions in nut butter compositions, Low Calorie Nut Butters and Processes for Their Production, Ser. No. 09/466,471 filed Dec. 17, 1999 and Freezable Low-Calorie Spoonable Dressings and Method for Their Production, filed Jun. 29, 2001.

Despite the considerable research performed in the field of synthetic fat and oil substitutes, an understanding of the precise relationship between the chemical structure of fat mimetics and digestibility remains lacking and the field remains a highly uncertain and unpredictable art. The technical literature related to fat substitutes (i.e., fat mimetics) includes conflicting observations and findings which cannot be easily reconciled or explained. For example, EP 0 2900 65 A2 regarding altered flavor presentations when SPE's were used to replace oil in some food applications. Thus, in the art of fat substitutes, there is no single model or theory that may be applicable to address the digestibility and organoleptically pleasing properties for fat substitutes.

All-natural tallow-like flavoring agents have been developed specifically for blending with vegetable oils to obtain frying mediums which have stable flavor over extended frying periods. These products mimic the physical characteristics of tallow derived from animal fat, such as the solid fat index (“SFI”), melting point and flavor, when combined with hydrogenated corn, soybean and canola oils. These compositions generally comprise around 0.5% to 2.0% flavorings with the balance conventional oil. Because the flavoring agents are combined with conventional oil, they have about the same caloric content as tallow obtained from animal fat.

Unsaturated or low saturated frying oils comprising saturated fatty acids, oleic acid and a mixture of minor fatty acids contained in tallow, lard and animal fats is discussed in U.S. Pat. No. 5,169,670. This patent discusses esterifying a glycerine with a mixture of 5% to 80% oleic acid, 15% or less saturated fatty acid and the balance minor fatty acids derived from animal fats. Although no specific theory regarding the flavor notes of the oil in this patent is adopted, it is postulated that the flavor notes result from oxidation products of oleic acid and oxidation of minor fatty acids released from the animal fat due to hydrolysis. The composition described in this patent is not an EPG composition and may have caloric content and cholesterol.

U.S. Pat. No. 5,304,665 discusses EPG compositions but has no disclosure regarding flavor notes of the EPG compositions or how to arrive at fat mimetic compositions which develop characteristic flavor notes during frying. Contrary to experimentation which resulted, in part, in the inventions described in U.S. Pat. No. 5,034,665 wherein soy based EPG compositions did not exhibit a beany flavor note in fried foods, the tallow based EPG compositions described herein did, unexpectedly, exhibit a corresponding tallow flavor in fried foods.

It has now been unexpectedly discovered that EPG compositions synthesized by using fatty acids derived from natural animal or beef tallow will result in oil replacement compositions that impart a savory beefy or tallow flavor to fried foods. The flavor imparted to the fried food is not significantly different from the flavor obtained when commercial edible tallow is used for frying. These EPG compositions are essentially non-digestible and contain no cholesterol. Thus, the EPG compositions synthesized using fatty acids from natural animal or beef tallow provides a frying medium that develops characteristic flavor notes during frying and imparts the distinct and savory beefy or tallow flavor to fried foods without adding calories or cholesterol to the fried food products.

In the present specification and claims, all parts and percentages are on a weight/weight basis unless otherwise specified.

### SUMMARY OF THE INVENTION

EPG compositions are, generally, made by incorporating propylene oxide (sometimes referred to herein as “oxypropylene” or “PO”) groups into a typical triglyceride fat as described in White. The average number of PO groups which are incorporated into a triglyceride is called the propoxylation number. The melting profile and other characteristics of the composition can be modified by adjusting the propoxylation number of a triglyceride, combining (i.e., employing as ingredients in a recipe) two or more different EPGs with different propoxylation numbers but the same fatty acid composition, combining two or more EPGs with different fatty acid compositions and the same or different propoxylation numbers, and any combination thereof.

The EPG compositions having characteristic flavor notes during frying which impart savory beefy or tallow flavor to foods are synthesized by using fatty acids derived from natural animal or beef tallow. Tallow is obtained by rendering beef or mutton fats, or combinations thereof, and the fatty acids used to synthesize the EPG compositions are obtained from splitting the acids from the rendered animal fat and are not synthesized or obtained by hydrolysis of fatty acids from oils or non-animal fats. The primary fatty acids in natural tallow are myristic acid, stearic acid and oleic acid. Although the primary fatty acids of tallow are identical to those obtained from oils and non-animal fats, the characteristic flavor notes are only observed by using the fatty acids derived from tallow. While not wishing to be bound by theory, it is believed that minor components of the rendered tallow may be important in the development of the characteristic tallow flavor. The EPG compositions have about 3 to about 14 oxypropylene groups per unit glycerin and are synthesized by the methods described herein.

It is discovered that by using fatty acids derived from natural animal or beef tallow to esterify the propoxylated glycerin, an oil replacement composition, useful as a frying medium, is obtained that has no cholesterol or caloric content but imparts a flavor to food reminiscent to that of tallow. This is surprising because inter-esterification of oils is used to change the characteristics of that oil. The randomization of fatty acids within the triglyceride changes the oil melt characteristics and oxidative and flavor stability.

The EPG compositions can be used to make reduced calorie food products, including, for example, snack food, such as potato chips, corn chips and the like and fried foods, such as french fries, fried vegetables or meats and the like. The EPG compositions have a cholesterol content of less than 1 mg of cholesterol per 100 grams of EPG composition (less than 0.001%).

### DETAILED DESCRIPTION OF THE INVENTION

The oil replacement compositions of the invention comprise EPG compositions which are made by incorporating propylene oxide groups, for purposes of the invention about 3 PO groups to about 14 PO groups, more preferably about 3 PO groups to about 8 PO groups, most preferably about 5 PO groups to about 8 PO groups, into a typical triglyceride fat as described in White. The average number of PO groups which are incorporated into a compound is called the propoxylation number. The fat replacement compositions can be comprised of one EPG, a mixture of two or more EPGs having different propoxylation numbers but the same fatty acid composition, a mixture of two or more EPGs having the same or different propoxylation numbers and different fatty acid compositions, and any combination thereof.

The fatty acid-esterified propoxylated glycerin compositions of this invention contain glyceryl residues, oxypropylene units, and C₁₂to C₂₄ fatty acid

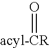

groups. The fatty acid residues are derived from natural beef or animal tallow, which have a low level of unsaturation or are fully saturated, such residues have low iodine values from about 38 to about 48. The high level of saturation precludes fatty acid oxidation of the compound at elevated temperatures, which is desired in a frying oil because fatty acid oxidation of the EPG would deteriorate the quality of the oil.

Typically, the compositions are mixtures of individual fatty acid-esterified propoxylated glycerin compounds which may differ from each other in degree of propoxylation and acyl group composition. The glyceryl residue may have the generic structure

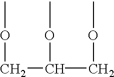

and is derived from glycerin

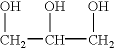

or a glycerin equivalent. The oxypropylene units are generally interspersed between glyceryl residues and the fatty acid acyl groups and have the structure

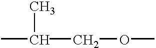

or

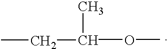

Typically, more than one oxypropylene unit may be present between an oxygen of an individual glyceryl residue and an acyl group such that a polyoxypropylene unit is created. However, a single “branch” or “arm” of the fatty acid-esterified propoxylated glycerin may contain only one oxypropylene unit. Certain of the acyl groups may be attached directly to the glyceryl residue, without any intervening oxypropylene units. The EPG compositions have about 3 to about 14 oxypropylene units per glyceryl residue.

It is desirable for the fatty acid-esterified propoxylated glycerin composition to be substantially esterified such that it has an average of at least about 2.5 (more preferably, at least about 2.9) fatty acid acyl groups per equivalent of glycerin. The extent of esterification may be readily determined by conventional analytical methods such as hydroxyl number. The fatty-acids must be derived from natural animal or beef tallow and are predominantly myristic acid, stearic acid and oleic acid or combinations thereof. Use of fatty acids derived form natural animal or beef tallow results in an EPG composition with a fatty acid composition not significantly different from commercial edible tallow. The EPG compositions with fatty acids derived from natural animal or beef tallow unexpectedly develop characteristic tallow flavor notes during frying and will impart a flavor to the food reminiscent of tallow in fried foods, but does not provide significant calories or cholesterol to the food product. Also, the tallow based fatty acids being highly or fully saturated, resists oxidation that may occur with other types of EPG compositions and would deteriorate the quality of the frying oils.

The structure of the EPG composition preferably is such that the composition has a porcine pancreatic lipase hydrolysis index of less than about 15 based on an olive oil standard of 100, i.e., the amount of hydrolysis of the EPG composition is 15 percent of the amount of fatty acids of olive oil hydrolyzed by the same amount of porcine pancreatic lipase under the same conditions. Methods of measuring porcine pancreatic lipase hydrolysis rate are described in White.

In order to maximize the resistance of the composition towards pancreatic lipase enzyme-catalyzed hydrolysis, the oxypropylene units adjacent to the acyl groups should be oriented such that secondary rather than primary ester linkages are created. That is, the methyl group should be located on the carbon atom attached to the oxygen atom forming part of the ester linkage as follows:

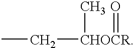

Preferably, at least about 80 percent of the ester linkages in the overall composition are secondary. Most preferably, at least about 95 percent of the ester linkages are secondary. However, the secondary ester content can be less than about 80 percent without adversely affecting the organoleptic properties of the invention.

The average number of oxypropylene units in the EPG must not be so low as to result in a high proportion of the acyl groups being attached directly to glyceryl residues since such directly attached acyl groups will be nearly as susceptible to enzymatic cleavage as the acyl groups in a conventional fully digestible triglyceride lipid, thus reducing the usefulness of the composition as a low calorie fat substitute.

EPGs are prepared using either fatty acids or fatty acid derivatives such as fatty acid esters, fatty acid halides, or fatty acid anhydrides that are derived from natural animal or beef tallow. Generally speaking, these fatty acids are predominantly myristic acid, stearic acid and oleic acid, or combinations thereof, which are C₁₂-C₂₄ fatty acids. The C₁₂-C₂₄ saturated fatty acid is linear (i.e., nonbranched) and preferably contains only one carboxylic acid functionality. The acyl group may thus correspond to the general structure

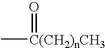

wherein n is an integer of from 10 to 22. The fatty acids from animal or beef tallow generally have low levels of unsaturation, with iodine values from about 38 to about 48. This aspect of tallow based fatty acids are particularly desirable for frying mediums (oil) because the high level of saturation precludes oxidation at the elevated temperatures associated with frying. Fatty acids from other sources, may not have the degree of saturation of fatty acids from animal or beef tallow, and would be subject to oxidation when used as a frying oil which deteriorates the quality of the oil. Also, the fatty acids from animal or beef tallow used for the EPG frying oil compositions provide a fat substitute frying oil which unexpectedly imparts a savory beefy or tallow flavor to the substrate. EPG compositions with fatty acids from other sources, such as soybean oil or rapeseed oil, do not develop characteristic flavor notes during frying and do not impart flavor characteristics to fried foods.

The average number of fatty acid acyl group carbons per equivalent of glycerin in the EPG compositions of the invention may be readily calculated from a knowledge of the fatty acid acyl group content (i.e., the chemical structures and relative proportions of the fatty acids used to prepare the compositions). The following formula may be used to calculate this average number (Nₐ) for an EPG composition prepared using fatty acids A and B:

$${N}_{a} = \frac{moles A \times no . carbons in A}{moles propoxylated glycerin} + \frac{moles B \times no . carbons in B}{moles propoxylated glycerin}$$

For example, a composition prepared by reacting a mixture of 1.5 moles of stearic acid (a C₁₈ fatty acid) and 1.5 moles of eicosanoic acid (a C₂₀ fatty acid) with 1 mole of propoxylated glycerin containing an average of 7 oxypropylene units per glycerin will have an average of 57 fatty acid acyl carbons per equivalent of glycerin.

To minimize the available caloric content of the EPG compositions, the chemical composition should be selected such that the number average molecular weight is at least about 800. More preferably, the minimum molecular weight is about 1,000; in order for the EPG composition to mimic as closely as possible the physical properties (such as texture, melting point, viscosity, heat stability and thermal conductivity) of conventional fat. It is also desirable that the number average molecular weight not exceed about 2,200. Preferably, the molecular weight is below about 2,000.

The EPG compositions may be prepared using any suitable method. In general, the procedures described in the prior art for synthesizing other EPG compositions will be appropriate for use provided that the fatty acids (or precursors thereof) or derivatives employed in the esterification step are obtained from edible beef or animal tallow. Such procedures are described, for example, in U.S. Pat. Nos. 4,861,613 (the White patent, referenced above) and 4,983,329, and in European Patent Publication No. 353,928, the disclosures of which are incorporated by reference herein in their entirety.

### EXAMPLE 1

Propoxylated glycerol with an average number of five oxyalkylene groups per glycerin molecule (propoxylation number) were synthesized in accordance with the methods described in White. These propoxylated glycerol compounds were then esterified with fatty acids derived from edible animal tallow. The esterified product was physically refined and fortified by the addition of a 0.15% blend of tocopherol blend (50% Covi-ox T70 and 50% Covitol F1300 both available from Henkel Corp., LaGrange, Ill., USA). The finished EPG composition was called EPG-05 Tallow.

A sample of the EPG-05 Tallow was analyzed for fatty acid content by gas chromatography using standard equipment and procedures as would be understood by one skilled in the art. For comparison purposes, a sample of commercial beef tallow was also analyzed using the same equipment and procedures. Table I sets forth the fatty acid composition of the EPG-05 Tallow and commercial beef tallow, based on the carbon chain length and number of double bonds of the fatty acid. As illustrated in Table I, the EPG-05 Tallow has a fatty acid content similar to that of the commercial beef tallow.

TABLE I
WEIGHT PERCENT OF FATTY ACID
IN COMPOSITIONS

| Fatty Acid Chain Length | EPG-05 | Commercial Beef |
|---|---|---|
| to Double Bond Ratio | Tallow | Tallow |
| 14:0 | 2.95 | 2.07 |
| 16:0 | 25.99 | 20.96 |
| 16:1 | 3.45 | 2.39 |
| 18:0 | 16.74 | 19.97 |
| 18:1 | 39.93 | 45.23 |
| 18:2 | 4.50 | 3.13 |
| Other | 6.44 | 6.25 |

Cholesterol analysis employing equipment and procedure known to those skilled in the art revealed less than 1 mg of cholesterol per 100 grams (less than 0.001%), which is below the limits of detection. Reported concentration of cholesterol in beef tallow ranges from about 0.08% to about 0.14%.

The EPG-05 Tallow was used for taste tests. Freshly peeled potatoes were cut into 3/8 inch thick strips, e.g french fries, stored in cold water and deep fried using the EPG-05 Tallow. Four fryings were performed per day over a five day period. A sensory panel evaluated the fried potato strips, e.g. french fried potatoes, after each trial run. The potato strips fried in EPG-05 Tallow exhibited a slight to moderate tallow flavor. The panel reported that the taste was reminiscent of the traditional flavor of french fried potatoes from commercial eating establishments, such as fast food restaurants.

### EXAMPLE 2 (COMPARATIVE)

Propoxylated glycerol with an average number of five oxyalkylene groups per glycerin molecule (propoxylation number) were synthesized in accordance with the methods described in White. These propoxylated glycerol compounds were then esterified with soybean fatty acids. The esterified product was physically refined and fortified by the addition of a 0.15% blend of tocopherol (50% covi-ox T70 and 50% covitol F1300) available from Henkel Corporation. The finished EPG composition was called EPG-05 Soyate.

The EPG-05 Soyate was then used as a frying medium to prepare french fries. Freshly peeled potatoes were cut into 3/8 inch thick strips, e.g french fries, stored in cold water and deep fried using the EPG-05 Soyate. The french fried potatoes prepared with EPG-05 Soyate were predominately noted as having a potato flavor. The frying oil medium made with EPG based on soybean oil fatty acids did not develop the characteristic beany flavor notes of soybean oil.

### EXAMPLE 3

Using procedures outline for Example 1, two additional tallow based EPG compositions were prepared. These EPG Compositions had an average number of three oxyaklylene groups per glycerin molecule (EPG-03 Tallow) and an average number of fourteen oxyalkylene groups per glycerin molecule (EPG-14 Tallow). Cholesterol Analysis on those compositions again were below the limits of detection (less than 1 mg/100 g).

What is claimed is:

1. A low-calorie frying oil which imparts a tallow flavor but no cholesterol to food comprising a fatty acid-esterified propoxylated glycerin composition wherein the fatty acids of the fatty acid-esterified propoxylated glycerin composition are derived from natural beef tallow and/or natural animal tallow and has an iodine value between about 38 and about 48.

2. The frying oil of claim 1, wherein the fatty acid-esterified propoxylated glycerin has about 3 to about 14 oxypropylene units per glycerine molecule.

3. The frying oil of claim 1 wherein the fatty acid-esterified propoxylated glycerin has an average molecular weight from about 800 to about 2,200.

4. The frying oil of claim 1, wherein the fatty acid-esterified propoxylated glycerin has a porcine pancreatic lipase hydrolysis index of less than about 15 based on an olive oil standard of 100.

5. The frying oil of claim 1, wherein the fatty acid-esterified propoxylated glycerin has less then about 1 mg of cholesterol per 100 grams of fatty acid-esterified glycerin.

6. A fried food having a fat component comprising a fatty acid-esterified propoxylated glycerin composition wherein the fatty acids of the fatty acid-esterified propoxylated glycerin and derived from natural beef tallow and/or natural animal tallow and have an iodine value of between about 38 and about 48.

7. The fried food of claim 6, wherein the fatty acid-esterified propoxylated glycerin composition has about 3 to about 14 oxypropylene units per glycerine molecule.

8. The fried food of claim 6, wherein the fatty acid-esterified propoxylated glycerin has an average molecular weight from about 800 to about 2,200.

9. The fried food of claim 6, wherein the fatty acid-esterified propoxylated glycerin has a porcine pancreatic lipase hydrolysis index of less than about 15 based on an olive oil standard of 100.

10. The fried food of claim 6, wherein the fatty acid-esterified propoxylated glycerin has less than about 1 mg of cholesterol per 100 grams of fatty acid-esterified propoxylated glycerin.

11. A method of making a frying oil comprising the step of esterifying a propoxylated glycerin with fatty acids derived from natural beef tallow and/or natural animal tallow having an iodine value of between about 38 and about 48 to obtain a fatty-acid esterified propoxylated glycerin which imparts a tallow flavor but no cholesterol to food.

12. The method of claim 11, wherein the fatty acid-esterified propoxylated glycerin has about 3 to about 14 oxypropylene units per glycerine molecule.

13. The method of claim 11, wherein the fatty acid-esterified propoxylated glycerin has an average molecular weight from about 800 to about 2,200.

14. The method of claim 11, wherein the fatty acid-esterified propoxylated glycerin has a porcine pancreatic lipase hydrolysis index of less than about 15 based on an olive oil standard of 100.

15. The method of claim 11, wherein the fatty acid-esterified propoxylated glycerin has less than about 1 mg of cholesterol per 100 grams of fatty acid-esterified propoxylated glycerin.
